(19) United States
(12) Patent Application Publication
(10) Pub. No.: US 2013/0235445 A1
(43) Pub. Date: Sep. 12, 2013

(54) DISPLAY ELEMENT AND ELECTRIC DEVICE THAT USES THE SAME

(71) Applicants: Tomoko Teranishi, Osaka (JP); Shun Ueki, Osaka (JP); Takuma Tomotoshi, Osaka (JP); Toshiki Matsuoka, Osaka (JP)

(72) Inventors: Tomoko Teranishi, Osaka (JP); Shun Ueki, Osaka (JP); Takuma Tomotoshi, Osaka (JP); Toshiki Matsuoka, Osaka (JP)

(73) Assignee: Sharp Kabushiki Kaisha, Osaka (JP)

(21) Appl. No.: 13/885,669

(22) PCT Filed: Nov. 8, 2011
(86) PCT No.: PCT/JP2011/075652

§ 371 Date: May 15, 2013

(30) Foreign Application Priority Data
Nov. 15, 2010 (JP) 2010-255067

(51) Int. Cl. G02B 26/00

(52) U.S. Cl. CPC G02B 26/005
USPC 359/290

(57) ABSTRACT

Oil (an insulating fluid) (17), which does not mix with a polar liquid (16), is enclosed within each of multiple pixel regions (p), in a display element (10) which is equipped with an upper substrate (a first substrate) (2), a lower substrate (a second substrate) (3), the polar liquid (16) which is enclosed within a display space (S) formed between the upper substrate (2) and the lower substrate (3) so as to be movable toward an effective display region (P1) or a non-effective display region (P2). Furthermore, a surface active agent (19) is added to at least one of the polar liquid (16) and the oil (17).

### TECHNICAL FIELD

The present invention relates to a display element that displays information such as images or characters by moving a polar liquid, and an electric device that uses the same.

### BACKGROUND ART

In recent years, as represented by an electrowetting type display element, a display element that displays information using a phenomenon in which a polar liquid is moved by an external electric field has been developed, and put to practical use.

Specifically, in the display element in the related art described above, as disclosed in PTL 1, for example, a display space is formed between first and second substrates, and ribs (partition walls) internally partition the display space, corresponding to each of the multiple pixel regions. Furthermore, in the display element in the related art, a conductive liquid (a polar liquid) is enclosed in each pixel region described above, and a scanning electrode and a standard electrode (a reference electrode), which are provided in parallel to each other, and a signal electrode are provided so as to intersect each other. In the display element in the related art, a voltage is appropriately applied to the signal electrode, the scanning electrode, and the standard electrode so as to move the conductive liquid toward the scanning electrode or the standard electrode and change a display color on a display surface in each pixel region.

### CITATION LIST

### Patent Literature

PTL 1: International Publication No. WO 2008/155925

### SUMMARY OF INVENTION

### Technical Problem

In the above-described display element in the related art, oil (an insulating fluid) that does not mix with the conductive liquid is enclosed in each pixel region, in order to easily accomplish an increase in a moving speed of the conductive liquid (the polar liquid).

However, in the above-described display element in the related art, when a voltage is applied, there is a concern in that integration of the conductive liquids occurs between the adjacent pixel regions. As a result, in the display element in the related art, an amount of conductive liquid within the pixel region may be inappropriate, and thus there is a concern in that a display defect such as a point defect occurs.

Specifically, in the display element in the related art, in order to increase the moving speed of the conductive liquid within the pixel region, the pixel regions are not completely sealed by the ribs, and a gap through which the adjacent pixel regions communicate with each other is provided, for example, in four corners of the pixel region in the shape of a rectangle. For this reason, in the display element in the related art, when the voltage is applied to move the conductive liquid, the oil flows wildly in some cases in response to the movement of the conductive liquid. Because of this, in the display element in the related art, the conductive liquid may be transformed excessively and come into contact with the conductive liquid of the adjacent pixel region through the gap described above. When the conductive liquids come into contact with each other in this manner, because the conductive liquids have high surface tensions, the conductive liquids are instantly integrated (unified). As a result, in the display element in the related art, an amount of conductive liquid within the pixel region is inappropriate and thus there is a concern in that the display defect such as the point defect occurs.

It is considered that the broadening of the width of the ribs that define the adjacent pixel regions by partitioning, for example, prevents the conductive liquids within the adjacent pixel regions from being integrated, but in a case of this configuration, an opening ratio of the display element decreases, and additionally there occurs another problem in that it is difficult to perform a high-definition display.

Furthermore, it is considered that a change in the size and the shape of the rib, for example, decreases the gap described above, and the pixel regions are defined by airtight (complete) partitioning, but in a case of this configuration, there occurs another problem in that the moving speed of the conductive liquid is decreased greatly.

Considering the problems described above, the present invention aims to provide a display element that can prevent occurrence of integration of polar liquids between adjacent pixel regions and thus can prevent occurrence of a display defect, and an electric device that uses the display element.

### Solution to Problem

To accomplish the object described above, according to the present invention, there is provided a display element which includes a first substrate that is provided on a display surface side, a second substrate that is provided on a non-display surface side of the first substrate so that a predetermined display space is formed between the first substrate and the second substrate, an effective display region and a non-effective display region that are defined with respect to the display space, and a polar liquid that is enclosed within the display space so as to be movable toward the effective display region, or toward the non-effective display region, and in which a display color on the display surface side is changeable, by moving the polar liquid, the display element including: a plurality of signal electrodes which are provided within the display space so as to come into contact with the polar liquid and which are arranged along a predetermined arrangement direction; a plurality of scanning electrodes which are provided on one of the first and second substrates, in a state of being electrically insulated from the polar liquid, so as to be arranged in one of the effective display region and the non-effective display region, and which are provided so as to intersect the plurality of signal electrodes; a plurality of pixel regions, each of which is provided at an intersection portion where the signal electrode and the scanning electrode intersect each other; a rib which is provided on at least one of the first and second substrates so as to internally partition the display space corresponding to each of the plurality of the pixel regions; and an insulating fluid which is enclosed within the display space so as to be movable in every pixel region, and which does not mix with the polar liquid. In the display element according to the invention, a surface active agent is added to at least one of the polar liquid and the insulating fluid.

In the display element configured as described above, a surface active agent is added to at least one of the polar liquid and the insulating fluid. Thus, interfacial tensions of the polar liquid and the oil can be weakened unlike in an example in the related art, and integration of the polar liquids between the adjacent pixel regions can be prevented from occurring. As a result, a display defect can be prevented from occurring, unlike in the example in the related art.

In the display element described above, an amount of the surface active agent added in every pixel region is preferably determined using a molar quantity corresponding to the surface area of the polar liquid in the pixel region.

In this case, the amount of the added surface active agent can be defined as an appropriate value, and the integration of the polar liquids between the adjacent pixel regions can be securely prevented from occurring.

Preferably, the display element further include a signal voltage application unit which is connected to the plurality of signal electrodes, and which applies a signal voltage within a predetermined voltage range to each of the signal electrodes in accordance with information that is displayed on the display surface side; and a scanning voltage application unit which is connected to the plurality of scanning electrodes, and which applies one of a selection voltage that allows the polar liquid to move within the display space and a non-selection voltage that disallows the polar liquid to move within the display space, to each of the plurality of scanning electrodes in accordance with the signal voltage.

In this case, the display color of each pixel region can be appropriately changed.

In the display element described above, the plurality of pixel regions may be provided corresponding to a plurality of colors with which a full color display is possible on the display surface side.

In this case, a color image display can be performed by appropriately moving the polar liquid corresponding to each of the multiple pixels.

Preferably, the display element further includes a plurality of reference electrodes which are provided on one of the first and second substrates, in a state of being electrically insulated from the polar liquid and the scanning electrodes, so as to be arranged in the other of the effective display region and the non-effective display region, and which are provided so as to intersect the plurality of signal electrodes; and a reference voltage application unit which is connected to the plurality of reference electrodes, and which applies one of the selection voltage that allows the polar liquid to move within the display space and the non-selection voltage that disallows the polar liquid to move within the display space, to each of the plurality of the reference electrodes in accordance with the signal voltage.

In this case, a matrix drive type display element can be configured in which the display defect can be prevented from occurring, without providing a switching element in every pixel region.

Furthermore, in the display element described above, a dielectric layer is preferably stacked on surfaces of the reference electrodes and the scanning electrodes.

In this case, a moving speed of the polar liquid can be improved more easily by securely increasing an electric field that the dielectric layer applies to the polar liquid.

In the display element described above, the non-effective display region is preferably defined by a light blocking film that is provided on one of the first and second substrates, and the effective display region is preferably defined by an opening portion that is formed in the light blocking film.

In this case, the effective display region and the non-effective display region can be arranged in the display space appropriately and securely.

According to the present invention, there is provided an electric device which is equipped with a display unit that displays information including characters and images, and in which the display unit includes any one of the display elements described above.

In the electric device configured as described above, since the display element that can prevent occurrence of the integration of the polar liquids between the adjacent pixel regions and thus can prevent occurrence of the display defect is used in the display unit, a high-performance electric device can be easily configured which is equipped with the display unit excellent in a display quality.

### Advantageous Effects of Invention

According to the present invention, a display element that can prevent occurrence of integration of polar liquids between adjacent pixel regions and thus can prevent occurrence of a display defect, and an electric device that uses the display element can be provided.

### BRIEF DESCRIPTION OF DRAWINGS

FIG. 1 is a plan view for describing a display element according to a first embodiment of the present invention, and an image display device.

FIG. 2 is an enlarged plan view illustrating a configuration of constituent parts on an upper substrate that is illustrated in FIG. 1, when viewed from a display surface side.

FIG. 3 is an enlarged plan view illustrating a configuration of constituent parts on a lower substrate that is illustrated in FIG. 1, when viewed from a non-display surface side.

FIG. 4(a) and FIG. 4(b) are cross-sectional views, each illustrating the configuration of the constituent parts of the display element that is illustrated in FIG. 1 at the time of a non CF coloring display and at the time of a CF coloring display, respectively.

FIG. 5 is a view for describing a surface active agent in a polar liquid that is illustrated in FIG. 4(a).

FIG. 6(a) is a view for describing a process of forming a standard electrode and a scanning electrode that are illustrated in FIG. 4(a), and FIG. 6(b) is a view for describing a process of forming a dielectric layer that is illustrated in FIG. 4(a).

FIG. 7(a) is a view for describing a process of forming first and second rib members that are illustrated in FIG. 4(a), and FIG. 7(b) is a view for describing a process of forming a water repellent film that is illustrated in FIG. 4(a).

FIG. 8(a) is a view for describing a process of supplying the polar liquid and oil that are illustrated in FIG. 4(a), and FIG. 8(b) is a view for describing a process of adding the surface active agent that is illustrated in FIG. 5.

FIG. 9(a) is a view for describing a process of forming a color filter layer that is illustrated in FIG. 4(a), and FIG. 9(b) is a view for describing the process of forming the water repellent film that is illustrated in FIG. 4(a).

FIG. 10(a) is a view for describing a process of forming a signal electrode that is illustrated in FIG. 4(a), and FIG. 10(b) is a view for describing a final process of manufacturing the display element described above.

FIG. 11 (a) is a view for describing a state of the polar liquid that appears after finishing the process of adding the surface active agent, which is illustrated in FIG. 8(b), and FIG. 11 (b) is a view for describing a state of the polar liquid that appears after finishing the final manufacturing process, which is illustrated in FIG. 10(b).

FIG. 12 is a view for describing an operational example of the image display device described above.

FIG. 13(a) is a view for describing a process of supplying the polar liquid and the oil in the display element according to a second embodiment of the present invention, and FIG. 13(b) is a view for describing a process of adding the surface active agent in the display element according to the second embodiment of the present invention.

FIG. 14(a) is a view for describing a process of applying the surface active agent in the display element according to a third embodiment of the present invention, and FIG. 14(b) is a view for describing the process of supplying the polar liquid and the oil in the display element according to the third embodiment of the present invention.

### DESCRIPTION OF EMBODIMENTS

Desirable embodiments of a display element and an electric device according to the present invention are described in detail below, referring to the drawings. In the following description, a case is exemplified, in which the present invention is applied to the image display device equipped with a display unit that can display a color image. Furthermore, a dimension of a constituent member in each drawing does not faithfully represent a dimension ratio of each constituent member to an actual constituent member.

### First Embodiment

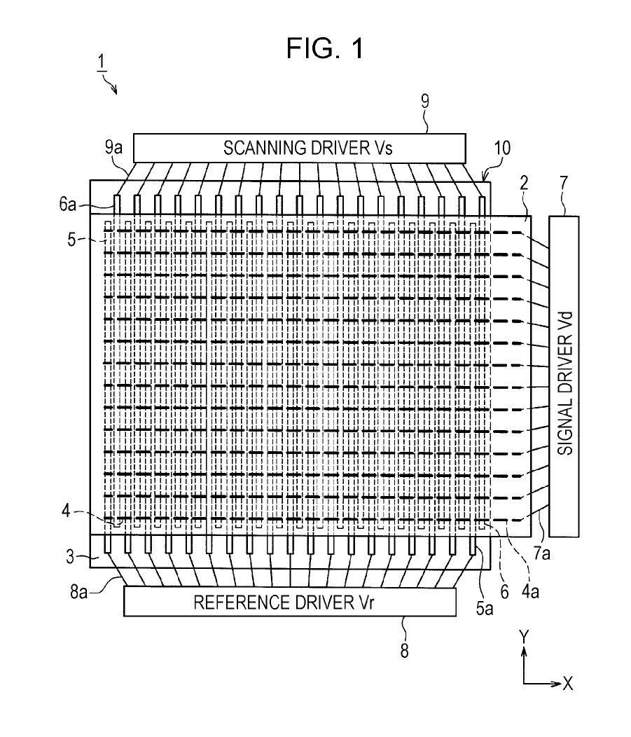

FIG. 1 is a plan view for describing a display element according to a first embodiment of the present invention, and an image display device. In FIG. 1, in an image display device 1 according to the present embodiment, a display unit is provided which uses a display element 10 according to the present invention, and the display unit is configured to have a rectangular-shaped display surface. That is, the display element 10 includes an upper substrate 2 and a lower substrate 3 that are arranged so as to overlap with each other in the direction that is perpendicular to the sheet of paper where FIG. 1 is drawn, and a portion where the upper substrate 2 and the lower substrate 3 overlap with each other forms an effective display region of the display surface described above (the details are described below).

Furthermore, in the display element 10, multiple signal electrodes 4 are provided in the form of stripes, along the X direction, with predetermined intervals between them. Furthermore, in the display element 10, multiple reference electrodes 5 and multiple scanning electrodes 6 are provided in the form of stripes, along the Y direction, so that the reference electrode and the scanning electrode alternate. The multiple signal electrodes 4, and the multiple reference electrode 5 and the multiple scanning electrode 6, are provided so that they intersect each other, and in the display element 10, each of the multiple pixel regions is provided at an intersection portion where the signal electrode 4 and the scanning electrode 6 intersect each other.

Furthermore, the multiple signal electrodes 4, the multiple reference electrodes 5 and the multiple scanning electrodes 6 are configured so that a voltage is independently applicable from each other within a predetermined voltage range between a HIGH voltage (hereinafter referred to as an “H voltage”) as a first voltage and a LOW voltage (hereinafter referred to as an “L voltage”) as a second voltage (the details are described below).

Furthermore, in the display element 10, as described in detail below, each of the multiple pixel regions is defined by the partition wall, and the multiple pixel regions are provided corresponding to multiple colors with which full color display is possible on the display surface described above. Then, in the display element 10, the polar liquid to be described below is moved in each of the multiple pixels (display cells) provided in the form of a matrix, under the influence of an electrowetting phenomenon, and thus the display color on the display surface side is changed.

Furthermore, in the multiple signal electrodes 4, the multiple reference electrodes 5 and the multiple scanning electrodes 6, one end portion of each extends outside of the effective display region of the display surface to form terminal portions 4a, 5a, and 6a.

A signal driver 7 is connected to each terminal portion 4a of the multiple signal electrodes 4 through wiring 7a. The signal driver 7 serves as a signal voltage application unit. In a case where the image display device 1 displays information including characters and images on the display surface, the signal driver 7 is configured to apply a signal voltage Vd, in accordance with the information, to each of the multiple signal electrodes 4.

Furthermore, a reference driver 8 is connected to each terminal portion 5a of the multiple reference electrodes 5 through wiring 8a. The reference driver 8 serves as a reference voltage application unit. In a case where the image display device 1 displays the information including the characters and the image on the display surface, the reference driver 8 is configured to apply a reference voltage Vr to each of the multiple reference electrodes 5.

Furthermore, a scanning driver 9 is connected to each terminal portion 6a of the multiple scanning electrodes 6 through wiring 9a. The scanning driver 9 serves as a scanning voltage application unit. In a case where the image display device 1 displays the information including the characters and the image on the display surface, the scanning driver 9 is configured to apply a scanning voltage Vs to each of the multiple scanning electrodes 6.

Furthermore, the scanning driver 9 applies either of a non-selection voltage that disallows the polar liquid described above to move and a selection voltage that allows the polar liquid to move in accordance with the signal voltage Vd, as the scanning voltage Vs, to each of the multiple scanning electrodes 6. Furthermore, the reference driver 8 is configured to operate by referring to the operation of the scanning driver 9, and the reference driver 8 applies either of the non-selection voltage that disallows the polar liquid to move, and the selection voltage that allows the polar liquid to move in accordance with the signal voltage Vd, as the reference voltage Vr, to each of the multiple reference electrodes 5.

The image display device 1 is configured in such a manner that the scanning driver 9, for example, applies sequentially the selection voltage to each scanning electrode 6 from the left side to the right side in FIG. 1, and the reference driver 8 sequentially applies the selection voltage to each reference electrode 5 from the left side to the right side in FIG. 1 in synchronization with the operation of the scanning driver 9, thereby performing a scanning operation every line (the details are described below).

Furthermore, a direct-current power supply or an alternating-current power supply is included in the signal driver 7, the reference driver 8 and the scanning driver 9 and supplies the corresponding signal voltage Vd, reference voltage Vr and scanning voltage Vs.

Furthermore, the reference driver 8 is configured to switch polarity of the reference voltage Vr every predetermined time (for example, one frame). Furthermore, the scanning driver 9 is configured to switch polarity of the scanning voltage Vs, corresponding to the switch in the polarity of the reference voltage Vr. In this manner, since each polarity of the reference voltage Vr and the scanning voltage Vs is switched every predetermined time, localization of electric charge in the reference electrode 5 and the scanning electrode 6 can be prevented, compared to a case where the voltage of the same polarity is always applied to the reference electrode 5 and the scanning electrode 6. Furthermore, a display defect (an afterimage phenomenon) and an adverse effect on reliability (a lifespan reduction), resulting from the localization of the electric charge, can be prevented.

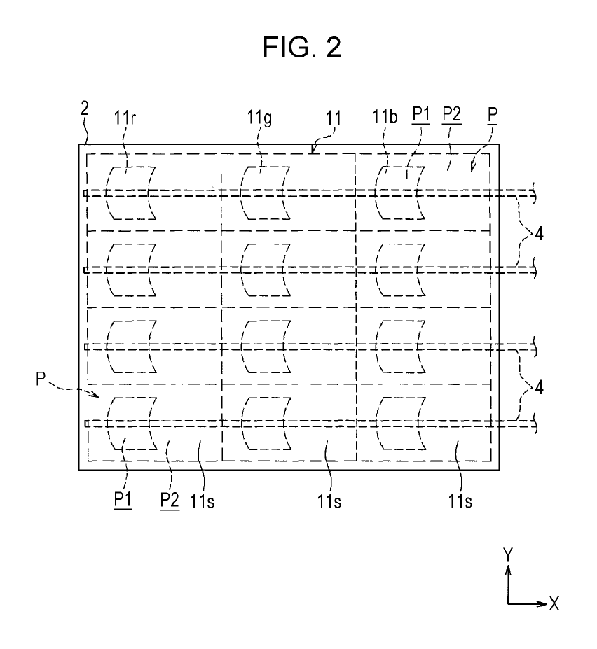

Here, a pixel structure of the display element 10 is described specifically, referring to FIG. 2 to FIG. 5 as well.

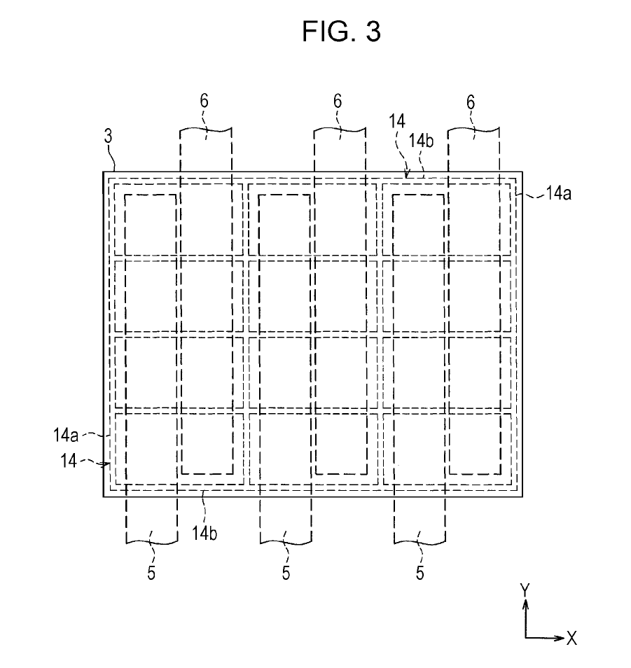

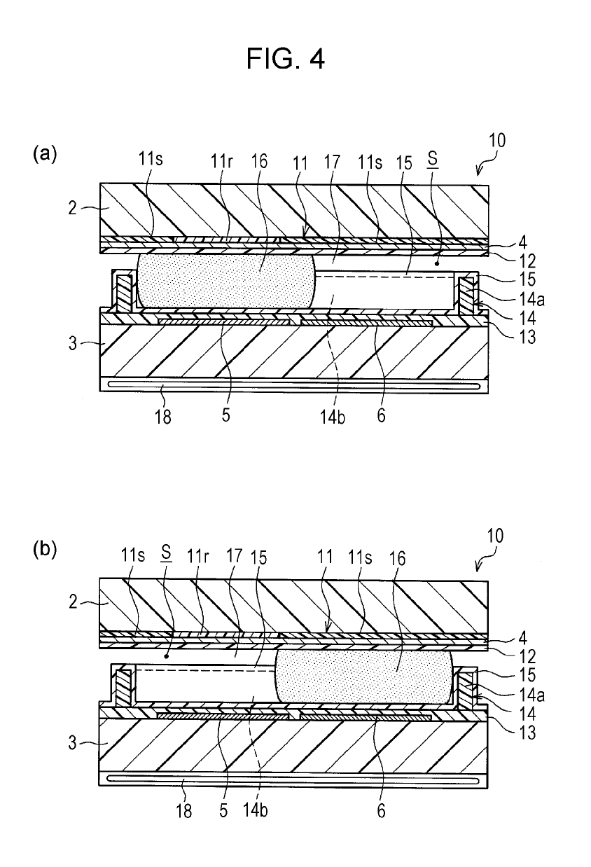

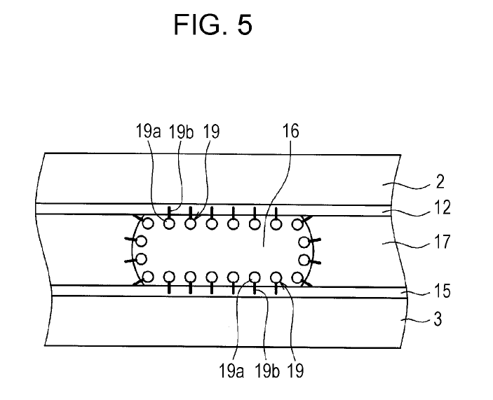

FIG. 2 is an enlarged plan view illustrating a configuration of constituent parts on an upper substrate that is illustrated in FIG. 1, when viewed from a display surface side. FIG. 3 is an enlarged plan view illustrating a configuration of constituent parts on a lower substrate that is illustrated in FIG. 1, when viewed from a non-display surface side. FIG. 4(a) and FIG. 4(b) are cross-sectional views, each illustrating the configuration of the constituent parts of the display element that is illustrated in FIG. 1 at the time of a non CF coloring display and at the time of a CF coloring display, respectively. FIG. 5 is a view for describing a surface active agent in the polar liquid that is illustrated in FIG. 4(a).

Among the multiple pixels provided on the display surface, the 12 pixels provided on the upper left edge part of FIG. 1 are illustrated in FIG. 2 and FIG. 3, for the purpose of simplifying the drawings. Furthermore, illustrations of a color filter layer 11, the signal electrode 4, the reference electrode 5, the scanning electrode 6, a dielectric layer 13 and a rib 14 are omitted in FIG. 5 for the purpose of simplifying the drawing.

In FIG. 2 to FIG. 4, the display element 10 includes the upper substrate 2, as a first substrate, which is provided on the display surface side, and the lower substrate 3, as a second substrate, which is provided on the rear surface side of the upper substrate 2 (on the non-display surface side). Furthermore, in the display element 10, the upper substrate 2 and the lower substrate 3 are arranged with a predetermined interval between them, thereby forming a predetermined display space S between the upper substrate 2 and the lower substrate 3. Furthermore, the polar liquid 16 described above and oil 17, as an insulating fluid which does not mix with the polar liquid 16, are enclosed within the display space S, in such a manner that they can be moved in the X direction (in the left-to-right direction in FIG. 4) within the display space S, and the polar liquid 16 can be moved toward an effective display region P1 or toward a non-effective display region P2 that is described below.

Furthermore, in the display element 10 according to the present embodiment, as described below, a predetermined amount of the surface active agent is added and is present on an interface between the polar liquid 16 and the oil 17, thereby reducing interfacial tensions of the polar liquid 16 and the oil 17. Then, the display element 10 according to the present embodiment is configured to prevent an integration of the polar liquids 16 from occurring between the adjacent pixel regions.

For example, a solution that includes water as a solvent and a predetermined electrolyte as a solute is used for the polar liquid 16. Specifically, for example, an aqueous solution of 1 mmol/L of potassium chloride (KCl) is used for the polar liquid 16. Furthermore, the polar liquid 16 that is colored in a predetermined color, for example, in black, using a self-distributed pigment is used.

Furthermore, since the polar liquid 16 is colored in black, the polar liquid 16 functions as a shutter that allows or disallows passing of light in each pixel. That is, each pixel of the display element 10, as described in detail below, is configured in which the polar liquid 16 slidably moves toward the reference electrode 5 (toward the effective display region P1) or toward the scanning electrode 6 (toward the non-effective display region P2) within the display space S, thereby changing a display color to black or any one of RGB.

Furthermore, for example, non-polar, colorless, transparent oil, which is made from one type or multiple types that are selected from side chain high quality alcohol, side chain high quality fatty acid, alkane hydrocarbon, silicone oil, and matching oil, is used for the oil 17. Furthermore, in association with the slide movement of the polar liquid 16, the oil 17 moves within the display space S.

A transparent glass material, such as a non-alkaline glass substrate, or a transparent sheet material, for example, transparent synthetic resin, such as acrylic-based resin, is used for the upper substrate 2. Furthermore, the color filter layer 11 and the signal electrode 4 are sequentially formed on the surface of the upper substrate 2 on the non-display surface side, and additionally a water repellent film 12 is provided to cover the color filter layer 11 and the signal electrode 4.

Furthermore, as is the case with the upper substrate 2, the transparent glass material, such as the non-alkaline glass substrate, or the transparent sheet material, for example, the transparent synthetic resin, such as the acrylic-based resin, is used for the lower substrate 3. Furthermore, the reference electrode 5 and the scanning electrode 6 are provided on the surface of the lower substrate 3 on the display surface side, and additionally the dielectric layer 13 is formed to cover the reference electrode 5 and the scanning electrode 6. Furthermore, a frame-shaped rib 14, which has a first rib member 14a and a second rib member 14b that are provided to be parallel with each other in the Y direction and in the X direction, is provided on the surface of the dielectric layer 13 on the display surface side. Furthermore, in the lower substrate 3, the water repellent film 15 is provided to cover the dielectric layer 13 and the rib 14.

Furthermore, for example, a backlight 18 that emits white illumination light is integrally attached to the rear surface of the lower substrate 3 (on the non-display surface side), thereby making up a transmission type display element 10. Moreover, a light source, such as a cold cathode fluorescent tube or an LED is used for the backlight 18.

Color filter portions 11r, 11g, and 11b of red (R), green (G), and blue (B), and a black matrix portion 11s as a light blocking film, are provided in the color filter layer 11, thereby making up the pixel of each color of RGB. That is, in the color filter layer 11, the color filter portions 11r, 11g, and 11b of RGB, as illustrated in FIG. 2, are sequentially provided along the X direction, and the color filter portions 11r, 11g, and 11b each including four pixels are provided along the Y direction. As a result, a total of the 12 pixels is arranged with the 3 pixels in the X direction and the 4 pixels in the Y direction.

Furthermore, in each pixel region P in the display element 10, as illustrated in FIG. 2, the color filter portion 11r, 11g, or 11b that corresponds to any one of RGB is provided on a place that corresponds to the effective display region P1 of the pixel, and the black matrix portion 11s is provided on a place that corresponds to the non-effective display region P2. That is, in the display element 10, the non-effective display region P2 (the non-opening portion) is defined with respect to the display space S described above by the black matrix portion (the light blocking film) 11s and the effective display region P1 is defined by an opening portion (that is, any one of the color filter portions 11r, 11g, and 11b) formed in the black matrix portion 11s.

Furthermore, in the display element 10, the same value as or a somewhat smaller value than for an area of the effective display region P1 is selected for each area of the color filter portions 11r, 11g, and 11b. On the one hand, the same value as or a somewhat greater value than for an area of the non-effective display region P2 is selected for an area of the black matrix portion 11s. Note that, a border line between the two black matrix portions 11s that corresponds to the adjacent pixels is indicated by a dotted line in FIG. 2 in order to distinctively define the border portion between the adjacent pixels, but in the actual color filter layer 11, the border line between the black matrix portions 11s is not present.

Furthermore, in the display element 10, the display space S is partitioned into units of the pixel regions P by the rib 14 as the partition wall described above. That is, in the display element 10, the display space S of each pixel, as illustrated in FIG. 3, is partitioned by the two first rib members 14a, which are opposite to each other, and the two second rib members 14b, which are opposite to each other. Furthermore, in the display element 10, the first and second rib members 14a and 14b prevent the polar liquid 16 from flowing into the display space S of the adjacent pixel regions P. That is, for example, an epoxy-resin-based resist material is used for the first and second rib members 14a and 14b, and in the first and second rib members 14a and 14b, protrusion heights (rib heights) from the dielectric layer 13 are determined so that an inflow and an outflow of the polar liquid 16 between the adjacent pixels are prevented.

Moreover, the case is described above, in which the frame-shaped rib 14 is used, but the present invention is not limited to this shape, and for example, a gap is provided in four corners of a frame-shaped portion.

Transparent synthetic resin, preferably, fluorine-based resin which becomes a hydrophilic layer with respect to the polar liquid 16 when a voltage is applied is, for example, used for the repellent films 12 and 15. Because of this, in the display element 10, wettability (a contact angle) can be greatly changed between the surface of the upper substrate 2 on the display space S side and the polar liquid 16, and between the surface of the lower substrate 3 on the display space S side and the polar liquid 16, and an increase in a moving speed of the polar liquid 16 can be accomplished. Furthermore, the dielectric layer 13 is made from a transparent dielectric film that contains, for example, parylene, silicon nitride, hafnium oxide, zinc oxide, titanium dioxide, or aluminum oxide. Moreover, a specific thickness of each of the water repellent films 12 and 15 is several tens nm to several μm, and a specific thickness of the dielectric layer 13 is several hundreds nm. Furthermore, the water repellent film 12 does not electrically insulate the signal electrode 4 and the polar liquid 16, and does not inhibit improvement in responsiveness in the polar liquid 16.

A transparent electrode material, such as indium oxide basis (ITO), tin oxide basis (SnO₂), or zinc oxide basis (AZO, GZO or IZO) is used for the reference electrode 5 and the scanning electrode 6. The reference electrode 5 and the scanning electrode 6 are formed on the lower substrate 3, in the form of a belt, using a known film formation method, such as sputtering.

Linear wiring, which is arranged to be parallel to the X direction, is used for the signal electrode 4. Furthermore, the transparent electrode material, such as ITO, is used for the signal electrode 4. Furthermore, the signal electrode 4 is arranged on the color filter layer 11 so as to pass through the almost middle portion of each pixel region P in the Y direction, and is configured to electrically come into contact with the polar liquid 16 via the water repellent film 12. Thus, in the display element 10, the improvement in responsiveness in the polar liquid 16 at the time of displaying operation is accomplished.

In each pixel of the display element 10 configured as described above, as illustrated in FIG. 4(a), when the polar liquid 16 is retained between the color filter portion 11r and the reference electrode 5, light from the backlight 18 is light-blocked by the polar liquid 16 and thus black display (non-CF coloring display) is performed. On the other hand, as illustrated in FIG. 4(b), when the polar liquid 16 is retained between the black matrix portion 11s and the scanning electrode 6, the light from the backlight 18 passes through the color filter portion 11r without being light-blocked by the polar liquid 16, and thus red display (CF coloring display) is performed.

Here, the surface active agent described above in the display element 10 according to the present embodiment is described specifically referring to FIG. 5 as well.

As illustrated in FIG. 5, a predetermined amount of the surface active agent 19 is present in an interface between the polar liquid 16 and the oil 17. Furthermore, the surface active agent 19 has a polar group 19a and a non-polar group 19b. Furthermore, in the display element 10 according to the present embodiment, the surface active agent 19 is first added to the oil 17, as described in detail below. Thereafter, the contact of the oil 17 with the polar liquid 16, as illustrated in FIG. 5, makes the polar group 19a of the surface active agent 19 added to the oil 17 oriented toward the polar liquid 16, and makes the non-polar group 19b oriented toward the oil 17 and toward the water repellent films 12 and 15. Then, the surface active agent 19 arranges itself for self-gathering in each interface between the polar liquid 16 and the oil 17, and between the polar liquid 16 and the water repellent films 12 and 15. Moreover, since the surface active agent 19 has the polar group 19a, the surface active agents 19, when in a predetermined added amount, seldom elutes into the non-polar oil 17.

Furthermore, the amount of the surface active agent 19 added in every pixel region P is determined using a molar quantity corresponding to the surface area of the polar liquid 16 within the pixel region P, and the amount of the added surface active agent 19 is set to a value with which at least the interface between the polar liquid 16 and the oil 17, the interface between the polar liquid 16 and the water repellent film 12, and the interface between the polar liquid 16 and the water repellent film 15 are covered in every pixel region P.

Specifically, a certain amount is determined as the amount of the added surface active agent 19 by conversion to a molar quantity [mol], and as described above, is determined using the molar quantity [mol] corresponding to the surface area of the polar liquid 16.

Here, the molar quantity [mol] corresponding to the surface area of the polar liquid 16 is obtained as follows. First, the molar quantity [mol] of the polar liquid 16 is calculated which corresponds to a volume of the polar liquid 16. Then, a ratio of the surface area (a total area of an area in contact with the upper substrate 2, an area in contact with the lower substrate 3, and an area of a lateral surface not in contact with the upper substrate 2 and the lower substrate 3) of the polar liquid 16 to the volume of the polar liquid 16 is calculated. Then, a multiplication of the molar quantity [mol] of the polar liquid 16 by the ratio is defined as the molar quantity [mol] corresponding to the surface area of the polar liquid 16.

In a case where the amount of the added surface active agent 19 is smaller than the value with which the interface between the polar liquid 16 and the oil 17, the interface between the polar liquid 16 and the water repellent film 12, and the interface between the polar liquid 16 and the water repellent film 15 are covered, that is, than a necessary minimum value, an effect that the integration of the polar liquids 16 is prevented by the surface active agent 19 cannot be obtained. More specifically, the case where the amount of the added surface active agent 19 is smaller than the necessary minimum value is a case where the added amount is equal to or less than 10% of the molar quantity [mol] corresponding to the surface area of the polar liquid 16.

Furthermore, in a case where the molar quantity of the added surface active agent 19 exceeds 100% of the molar quantity [mol] corresponding to the surface area of the polar liquid 16, the superfluous surface active agent 19 floats in places other than the interface between the polar liquid 16 and the oil 17, the interface between the polar liquid 16 and the water repellent film 12, and the interface between the polar liquid 16 and the water repellent film 15, and additionally, when the added amount is increased, the surface active agents 19 gather in the polar liquid 16 and thus form a micelle. Furthermore, when the added amount is further increased, the surface active agent 19 forms the reversed micelle in the oil 17 and thus floats in the oil 17. As described above, when the amount of the added surface active agent 19 is increased more than desired, liquid characteristics of the polar liquid 16 and the oil 17 may be changed and therefore a balance of the interfacial tension may be changed to have an influence on electrowetting characteristics, so that an adverse effect may be exerted on operational characteristics of the display element 10.

Furthermore, for the surface active agent 19, a surface active agent is used which has a chemical structure that is appropriately selected in accordance with chemical structures and physical properties of the polar liquid 16, the oil 17, and the water repellent films 12 and 15. Specifically, for example, negative ion based (anionic basis) or non-ion based (non-ion basis) surface active agent, or a dipolar ion surface active agent is used for the surface active agent 19.

Furthermore, the negative ion based surface active agent, described above, includes fatty acid basis (negative ion), such as pure soap content (fatty acid sodium), pure soap content (fatty acid potassium), or alpha sulfofatty acid ester sodium, linear alkylbenzene basis, such as linear alkylbenzene sulfonic acid sodium, high quality alcohol basis (negative ion) such as alkylsulfuric acid ester sodium, or alkyl ether sulfuric acid ester sodium, alpha olefin basis, such as alpha olefin sulfonic acid sodium, and normal paraffin basis, such as sodium alkylsulfonate.

Furthermore, the non-ion-basedsurface active agent, described above, includes fatty acid basis (non-ion), such as sucrose fatty acid ester sorbitan fatty acid ester, polyoxyethylene sorbitan fatty acid ester, or fatty acid alkanolamide, high quality alcohol basis (non-ion), such as polyoxyethylene alkyl ether, and alkylphenol basis, such as polyoxyethylene alkyl phenyl ether.

Furthermore, the dipolar ion surface active agent, described above, includes amino acid basis, such as alkyl amino fatty acid sodium, betaine basis, such as alkyl betaine, and amine oxide basis, such as alkylamine oxide.

Furthermore, the positive ion-based surface active agent, described above, includes quaternaty ammonium salt basis, such as alkyltrimethylammonium salt, or dialkyl dimethyl ammonium salt.

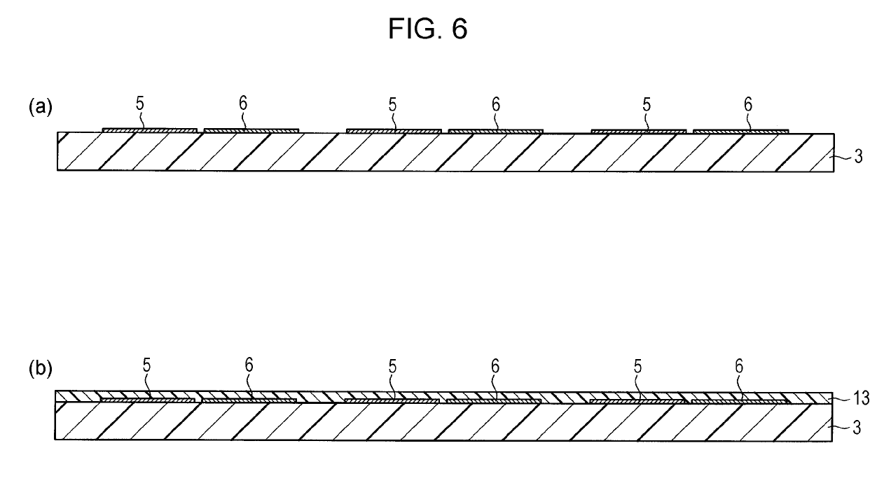

Here, a process of manufacturing the display element 10 according to the present embodiment is described specifically, referring to FIG. 6 to FIG. 10.

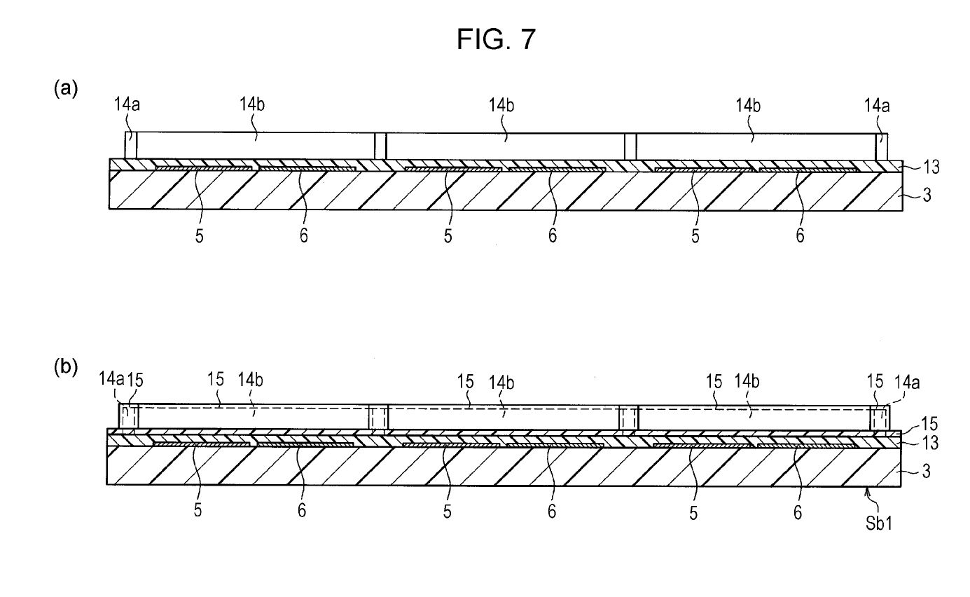

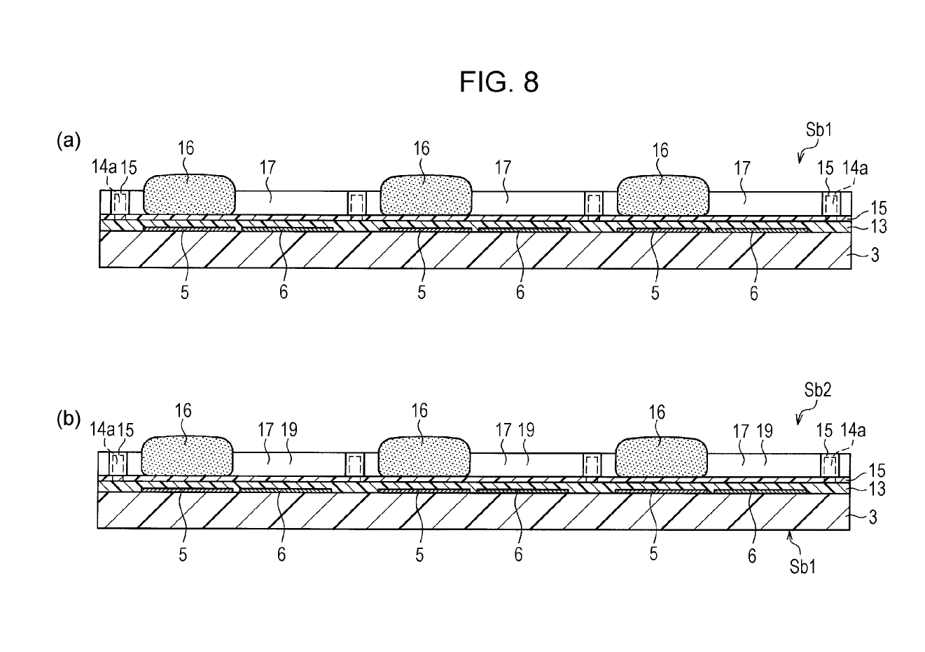

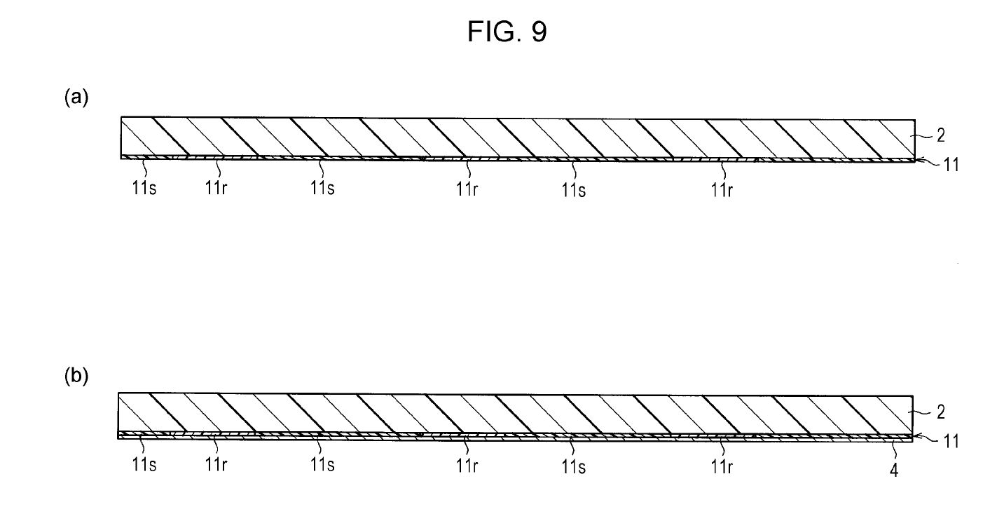

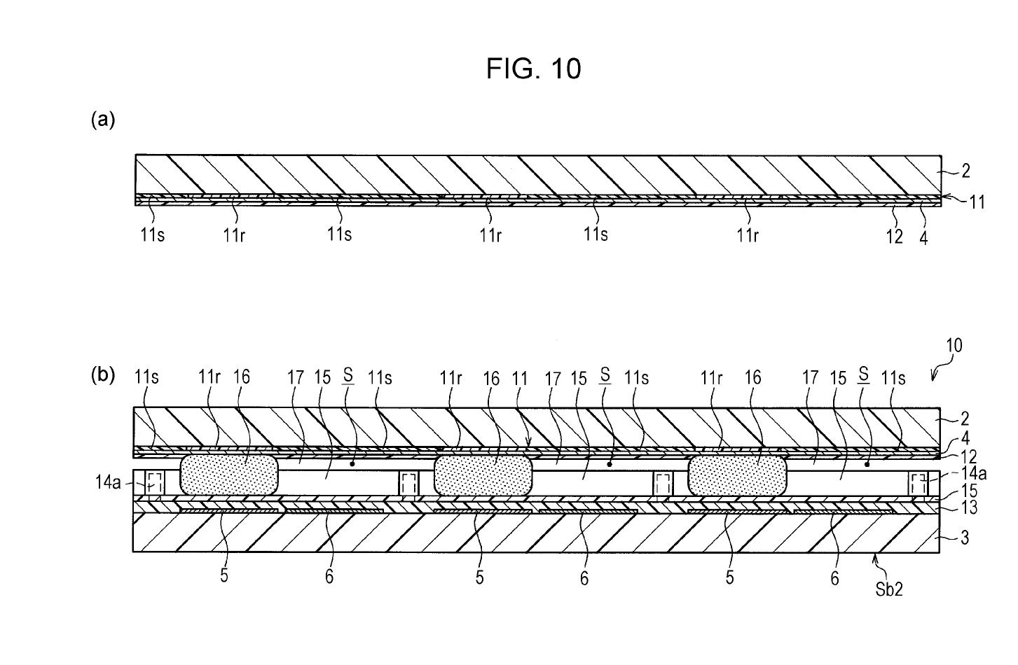

FIG. 6(a) is a view for describing a process of forming a standard electrode and a scanning electrode that are illustrated in FIG. 4(a), and FIG. 6(b) is a view for describing a process of forming a dielectric layer that is illustrated in FIG. 4(a). FIG. 7(a) is a view for describing a process of forming first and second rib members that are illustrated in FIG. 4(a), and FIG. 7(b) is a view for describing a process of forming a water repellent film that is illustrated in FIG. 4(a). FIG. 8(a) is a view for describing a process of supplying the polar liquid and oil that are illustrated in FIG. 4(a), and FIG. 8(b) is a view for describing a process of adding the surface active agent that is illustrated in FIG. 5. FIG. 9(a) is a view for describing a process of forming a color filter layer that is illustrated in FIG. 4(a), and FIG. 9(b) is a view for describing the process of forming the water repellent film that is illustrated in FIG. 4(a). FIG. 10(a) is a view for describing a process of forming a signal electrode that is illustrated in FIG. 4(a), and FIG. 10(b) is a view for describing a final process of manufacturing the display element described above.

In FIG. 6(a), for example, a non-alkaline glass substrate, which is 0.7 mm in thickness, is used for the lower substrate 3, and a process of forming the electrode on the lower substrate 3 is performed by film-forming an ITO film, 100 nm in thickness, on the surface of the lower substrate 3 using the sputter technique, and thus the standard electrode 5 and the scanning electrode 6 are formed. Furthermore, the standard electrode 5 and the scanning electrode 6 are provided so that they alternate in the longitudinal direction of the pixel region P.

Thereafter, as illustrated in FIG. 6(b), the process of forming the dielectric layer 13 is performed. That is, a silicon nitride film, as the dielectric layer 13, is formed on the lower substrate 3, the standard electrode 5 and the scanning electrode 6, for example, using a CVD technique. The dielectric layer 13 is, for example, 350 nm in thickness.

Next, in FIG. 7(a), the process of forming the first and second rib members 14a and 14b is performed. Specifically, the first and second rib members 14a and 14b, made from UV-cured resin, are formed on the surface of the dielectric layer 13, for every unit of the pixel region P, for example, using a photolithography technique. Thus, an arrangement process is completed in which the rib (the partition wall) 14 partitioning the display space S is provided on the lower substrate (one of the substrates) 3 side corresponding to the multiple pixel regions P provided on the display surface side.

Moreover, specific dimensions of the pixel region P in the X direction and in the Y direction is 2.7 mm and 1.8 mm, respectively (equivalent to dimensions of the display space S in the X direction and in the Y direction). Furthermore, in the first and second rib members 14a and 14b, a height from the dielectric layer 13 is 350 μm, and each width in the X direction and in the Y direction is, for example, 50 μm.

Thereafter, as illustrated in FIG. 7(b), the process of film-forming the water repellent film 15 is performed. That is, the water repellent film 15 is film-formed by applying a fluorine-based resin material on each surface of the dielectric layer 13, and the first and second rib members 14a and 14b, for example, using a dipping technique, and then burning the result at a temperature of 80° C. for 30 minutes. The dielectric layer 15 is, for example, 60 nm in thickness. Thus, an intermediate substrate Sb1 of the lower substrate 3 before the polar liquid 16 is retained is accomplished. Furthermore, because the lower substrate 3 is covered with the water repellent film 15, a portion with which the polar liquid 16 comes into contact is in a water repellent state and this makes it possible to smoothly move the polar liquid 16.

Subsequently, as illustrated in FIG. 8(a), the process of supplying the polar liquid 16 and the oil 17 is performed with respect to the intermediate substrate Sb1. In the process, after the oil 17 is first supplied, the polar liquid 16 is supplied. Specifically, with respect to the intermediate substrate Sb1, the oil 17 is supplied to each of the pixel regions P defined by the partitioning by the first and second rib members 14a and 14b, for example, using a dispensing apparatus, or an ink jet apparatus. Subsequently, the polar liquid 16 is supplied into each pixel region P, for example, using the dispensing apparatus, or the ink jet apparatus.

Next, as illustrated in FIG. 8(b), the process of adding the surface active agent 19 is performed with respect to the intermediate substrate Sb1. Specifically, the surface active agent 19 is added to the oil 17 within each pixel region P, for example, using the dispensing apparatus, or the ink jet apparatus. Thereafter, the surface active agent 19 moves to the polar liquid 16 that comes into contact with the oil 17, and as illustrated in FIG. 5, the polar group 19a is oriented toward the polar liquid 16, and the non-polar group 19b is oriented toward the oil 17, and the water repellent films 12 and 15. Thus, a finally-finished substrate Sb2 is obtained in terms of the lower substrate 3 in which the polar liquid 16 and the oil 17, to which the surface active agent 19 is added, are retained.

Furthermore, in FIG. 9(a), for example, the non-alkaline glass substrate, which is 0.7 mm in thickness, is used for the upper substrate 2. A CF forming process is performed by stacking the color filter portions 11r, 11g, and 11b and the black matrix portion 11s on the surface of the upper substrate 2, for example, using the photolithography technique, and thus the color filter layer 11 is formed. Photosensitive resin (for example, a light-sensitive acrylic monomer) and a corresponding pigment are used for the color filter layer 11, and for example, the color filter layer 11 is defined as approximately 2 μm in thickness.

Thereafter, as illustrated in FIG. 9(b), a process of forming the electrode on the upper substrate 2 is performed. That is, the signal electrode 4 is provided on the surface of the color filter layer 11, by fixing a fine line that is made from, for example, ITO.

Next, as illustrated in the FIG. 10(a), the process of film-forming the water repellent film 12 is performed. That is, the water repellent film 12 is film-formed, for example, by applying the fluorine-based resin material on the surfaces of the color filter layer 11 and the signal electrode 4, using the dipping technique, and then burning the result at a temperature of 80° C. for 30 minutes. The water repellent film 12 is, for example, 60 nm in thickness.

Then, as illustrated in FIG. 10(b), the display element 10 is accomplished by integrally attaching from above the upper substrate 2 to the lower substrate 3 where the polar liquid 16 and the oil 17 are retained, for example, using a UV adhesive agent. Moreover, a distance (gap) between the upper substrate 2 and the lower substrate 3 is, for example, 400 μm.

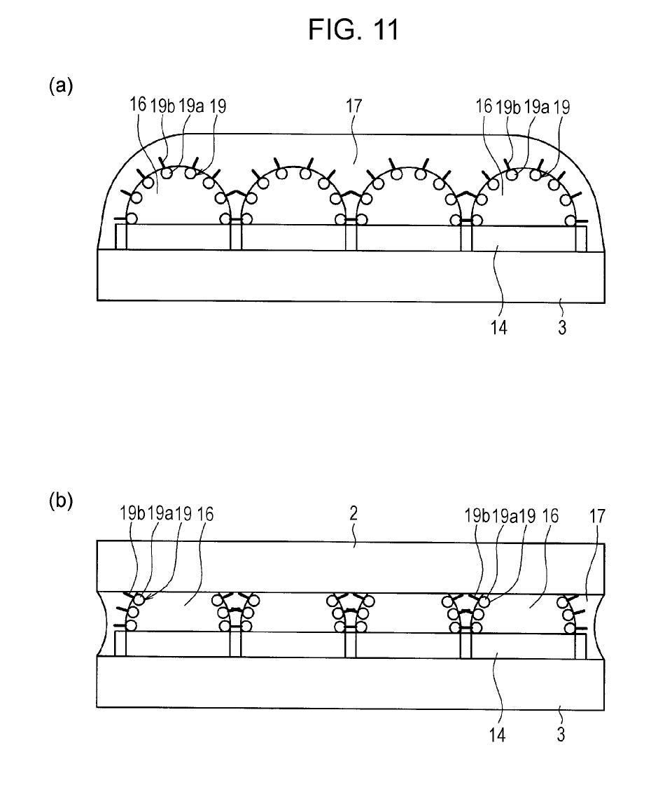

Subsequently, an effect obtained by the surface active agent 19 is described specifically, referring to FIG. 11 as well.

FIG. 11 (a) is a view for describing a state of the polar liquid that appears after finishing the process of adding the surface active agent, which is illustrated in FIG. 8(b), and FIG. 11 (b) is a view for describing a state of the polar liquid that appears after finishing a final manufacturing process, which is illustrated in FIG. 10(b). Moreover, in FIG. 11, the surface active agent 19 in each of the 4 adjacent pixel regions is illustrated.

As illustrated in FIG. 11(a), in a short time after the adding of the surface active agent 19 is finished, the surface active agent 19 naturally moves to the interface between the polar liquid 16 and the oil 17, and the polar group 19a and the non-polar group 19b are made to be present toward the polar liquid 16 and the oil 17, respectively.

Thereafter, as illustrated in FIG. 11(b), when the display element 10 is accomplished, the non-polar groups 19b of the surface active agent 19 face each other between the adjacent pixel regions P. Accordingly, in the display element 10 according to the present embodiment, the upper substrate 2 is attached to the lower substrate 3, from above, and thus even though the polar liquid 16 is transformed, to be more precise, even though the polar liquid 16 collapses flatly, as illustrated in FIG. 11(b), an occurrence of the integration of the polar liquids 16 between the adjacent pixel regions P is prevented.

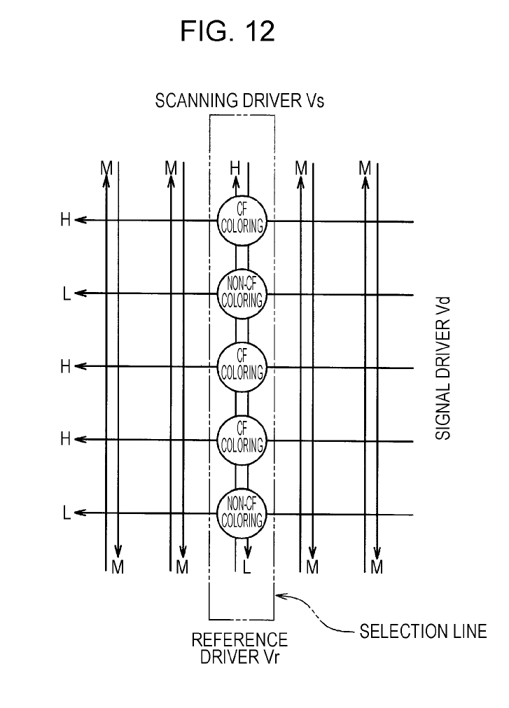

Here, the display operation of the image display device 1, configured as described above, according to the present embodiment, is described specifically referring to FIG. 12 as well.

FIG. 12 is a view for describing an operational example of the image display device described above.

In FIG. 12, the reference driver 8 and the scanning driver 9 sequentially apply the selection voltage described above, for example, as a reference voltage Vr and a scanning voltage Vs, to the reference electrode 5 and the scanning electrode 6, respectively, in a predetermined scanning direction that progresses from the left side to the right side in FIG. 12. Specifically, the reference driver 8 and the scanning driver 9 perform the scanning operation that sequentially applies a H voltage (a first voltage) and an L voltage (a second voltage), as the selection voltage, to the reference electrode 5 and the scanning electrode 6, respectively, and defines a selection line. Furthermore, in the selection line, the signal driver 7 applies the H voltage or the L voltage, as the signal voltage Vd, to the corresponding signal electrode 4, in accordance with an image input signal from the outside. Thus, in each pixel in the selection line, the polar liquid 16 is moved to the effective display region P1 or to the non-effective display region P2, and thus the display color on the display surface side is changed.

On the other hand, the reference driver 8 and the scanning driver 9 apply the non-selection voltage, described above, as the reference voltage Vr and the scanning voltage Vs, to a non-selection line, that is, to all the remaining reference electrodes 5 and scanning electrodes 6, respectively. Specifically, the reference driver 8 and the scanning driver 9 apply an intermediate voltage, which is, for example, a voltage intermediate between the H voltage and the L voltage, described above, (a middle voltage, hereinafter referred to as an “M voltage”), as the non-selection voltage, to all the remaining reference electrodes 5 and scanning electrodes 6. Thus, in each pixel in the non-selection line, the polar liquid 16 is stopped without causing the polar liquid 16 to produce an unnecessary movement toward the effective display region P1 or the non-effective display region P2, and thus the display color on the display surface side is not changed.

In a case where the display operation described above is performed, a combination of applications of voltages to the reference electrode 5, the scanning electrode 6, and the signal electrode 4 is expressed in Table 1. Furthermore, a behavior of the polar liquid 16 and the display color on the display surface side, as expressed in Table 1, depend on the applied voltage. Moreover, in Table 1, the H voltage, the L voltage, and the M voltage are abbreviated to “H,” “L,” and “M,” respectively (the same is true for Table 2 that is described below.). Furthermore, specific values of the H voltage, the L voltage, and the M voltage are, for example, +16 V, 0 V, and +8 V, respectively.

TABLE 1

| | Reference | Scanning | Signal | Behavior of polar liquid, |
|---|---|---|---|---|
| | elec- | elec- | elec- | and color display on display |
| | trode | trode | trode | surface side |
| Selection | H | L | H | Movement toward scanning |
| line | | | | electrode, CF coloring |
| | | | | display |
| | | | L | Movement toward reference |
| | | | | electrode, black display |
| Non- | M | M | H | Stop (no movement) |
| selection | | | L | Black or CF coloring |
| line | | | | display |

### Operation in Selection Line

In the selection line, because when the H voltage, for example, is applied to the signal electrode 4, the H voltage is concurrently applied between the reference electrode 5 and the signal electrode 4, an electric potential difference does not occur between the reference electrode 5 and the signal electrode 4. On the one hand, because the L voltage is applied to the scanning electrode 6, a state is produced in which the electric potential difference occurs between the signal electrode 4 and the scanning electrode 6. For this reason, in the display space S, the polar liquid 16 moves to the scanning electrode 6, where the electric potential difference occurs with respect to the signal electrode 4. As a result, as illustrated in FIG. 4(b), a state is produced in which the polar liquid 16 moves to the non-effective display region P2, and the oil 17 is moved to the reference electrode 5, and thus the illumination light from the backlight 18 is allowed to reach the color filter portion 11r. Thus, the display color on the display surface side is in a state of the red display (the CF coloring display) by the color filter portion 11r. Furthermore, in the image display device 1, in all the three pixels, the adjacent RGB, the polar liquid 16 moves to the non-effective display region P2, and thus when the CF coloring display is performed, red light, green light, and blue right from the corresponding RGB pixels are color-mixed into white light, thereby performing white display.

On the one hand, in the selection line, when the L voltage is applied to the signal electrode 4, the electric potential difference occurs between the reference electrode 5 and the signal electrode 4, and the electric potential difference does not occur between the signal electrode 4 and the scanning electrode 6. Accordingly, in the display space S, the polar liquid 16 moves to the reference electrode 5, where the electric potential difference occurs with respect to the signal electrode 4. As a result, as illustrated in FIG. 4(a), a state is produced in which the polar liquid 16 moves to the effective display region P1, and thus the illumination light from the backlight 18 is prevented from reaching the color filter portion 11r. Thus, the display color on the display surface side is in a state of the black display (the non-CF coloring display) by the polar liquid 16.

### Operation in Non-selection Line

In the non-selection line, when the H voltage, is applied to the signal electrode 4, for example, the polar liquid 16 is maintained in a state of being stopped in a current situational position, and thus is maintained in a current situational display color. That is, this is because the M voltage is applied to both of the reference electrode 5 and the scanning electrode 6, and therefore, because the electric potential difference between the reference electrode 5 and the signal electrode 4 and the electric potential difference between the scanning electrode 6 and the signal electrode 4 concurrently occur as the same electric potential difference. As a result, the display color is maintained without being changed from the current situational black display or from the CF coloring display.

Similarly, in the non-selection line, even when the L voltage is applied to the signal electrode 4, the polar liquid 16 is maintained in the state of being stopped in the current situational position, and thus is maintained in the current situational display color. That is, this is because the M voltage is applied to both of the reference electrode 5 and the scanning electrode 6, and therefore because the electric potential difference between the reference electrode 5 and the signal electrode 4 and the electric potential difference between the scanning electrode 6 and the signal electrode 4 concurrently occur as the same electric potential difference.

As described above, in the non-selection line, even though the signal electrode 4 is either of the H voltage and the L voltage, the polar liquid 16 stops without moving, and thus the display color on the display surface side does not change.

On the one hand, in the selection line, as described above, in accordance with the voltage applied to the signal electrode 4, the polar liquid 16 can be moved and the display color on the display surface side can be changed.

Furthermore, in the image display device 1, according to the combination of the applications of voltages expressed in Table 1, the display color in each pixel in the selection line, for example, as illustrated in FIG. 12, becomes the CF coloring (red, green, or blue) by the color filter portions 11r, 11g, or 11b, or the non-CF coloring (black) by the polar liquid 16, in accordance with the voltage applied to the signal electrode 4 corresponding to each pixel. Furthermore, in a case where the reference driver 8 and the scanning driver 9 perform the operation of scanning the selection lines of the reference electrode 5 and the scanning electrode 6, respectively, for example, from the left side of FIG. 12 to the right side, the display color of each pixel in the display unit of the image display device 1 is also sequentially changed in the direction that progresses from the left side of FIG. 12 to the right side. Therefore, in the image display device 1, the performing of the operation of scanning the selection line by the reference driver 8 and the scanning driver 9 at a high speed makes it possible to change the display color of each pixel in the display unit at a high speed as well. Furthermore, in the image display device 1, the performing of the application of the signal electrode Vd to the signal electrode 4 by synchronization with the operation of scanning the selection line makes it possible to display various items of information including moving images, based on the image input signal from the outside.

Furthermore, the combination of the applications of voltages to the reference electrode 5, the scanning electrode 6, and the signal electrode 4 is not limited to Table 1, and may be a combination expressed in Table 2.

TABLE 2

| | Reference | Scanning | Signal | Behavior of polar liquid, |
|---|---|---|---|---|
| | elec- | elec- | elec- | and color display on display |
| | trode | trode | trode | surface side |
| Selection | L | H | L | Movement toward scanning |
| line | | | | electrode, CF coloring |
| | | | | display |
| | | | H | Movement toward reference |
| | | | | electrode, black display |
| Non- | M | M | H | Stop (no movement) |
| selection | | | L | Black or CF coloring |
| line | | | | display |

That is, the reference driver 8 and the scanning driver 9 perform the scanning operation that sequentially applies the L voltage (the second voltage) and the H voltage (the first voltage), as the selection voltage, to the reference electrode 5 and the scanning electrode 6, respectively, for example, in the predetermined scanning direction that progresses from the left side of the same drawing to the right side, and thus define the selection line. Furthermore, in the selection line, the signal driver 7 applies the H voltage or the L voltage, as the signal voltage Vd, to the corresponding signal electrode 4, in accordance with an image input signal from the outside.

On the one hand, the reference driver 8 and the scanning driver 9 apply the M voltage, as the non-selection voltage, to the non-selection line, that is, to all the remaining reference electrodes 5 and scanning electrodes 6.

### Operation in Selection Line

In the selection line, because when the L voltages applied to the signal electrode 4, for example, the L voltage is concurrently applied between the reference electrode 5 and the signal electrode 4, the electric potential difference does not occur between the reference electrode 5 and the signal electrode 4. On the one hand, because the H voltage is applied to the scanning electrode 6, the state is produced in which the electric potential difference occurs between the signal electrode 4 and the scanning electrode 6. Accordingly, in the display space S, the polar liquid 16 moves to the scanning electrode 6, where the electric potential difference occurs with respect to the signal electrode 4. As a result, as illustrated in FIG. 4(b), a state is produced in which the polar liquid 16 moves to the non-effective display region P2, and the oil 17 is moved to the reference electrode 5, and thus the illumination light from the backlight 18 is allowed to reach the color filter portion 11r. Thus, the display color on the display surface side is in a state of the red display (the CF coloring display) by the color filter portion 11r.

Furthermore, like in the case expressed in Table 1, in all the three pixels, the adjacent RGB, when the CF color display is performed, the white display is performed.

On the one hand, in the selection line, when the H voltage is applied to the signal electrode 4, the electric potential difference occurs between the reference electrode 5 and the signal electrode 4, and the electric potential difference does not occur between the signal electrode 4 and the scanning electrode 6. Accordingly, in the display space S, the polar liquid 16 moves to the reference electrode 5, where the electric potential difference occurs with respect to the signal electrode 4. As a result, as illustrated in FIG. 4(a), a state is produced in which the polar liquid 16 moves to the effective display region P1, and thus the illumination light from the backlight 18 is prevented from reaching the color filter portion 11r. Thus, the display color on the display surface side is in a state of the black display (the non-CF coloring display) by the polar liquid 16.

### Operation in Non-Selection Line

In the non-selection line, when the L voltage, for example, is applied to the signal electrode 4, the polar liquid 16 is maintained in a state of being stopped in a current situational position, and thus is maintained in the current situational display color. That is, this is because the M voltage is applied to both of the reference electrode 5 and the scanning electrode 6, and therefore because the electric potential difference between the reference electrode 5 and the signal electrode 4 and the electric potential difference between the scanning electrode 6 and the signal electrode 4 concurrently occur as the same electric potential difference. As a result, the display color is maintained without being changed from the current situational black display or from the CF coloring display.

Similarly, in the non-selection line, even when the H voltage is applied to the signal electrode 4, the polar liquid 16 is maintained in the state of being stopped in the current situational position, and thus is maintained in the current situational display color. That is, this is because the M voltage is applied to both of the reference electrode 5 and the scanning electrode 6, and therefore because the electric potential difference between the reference electrode 5 and the signal electrode 4 and the electric potential difference between the scanning electrode 6 and the signal electrode 4 concurrently occur as the same electric potential difference.

As described above, also in the case expressed in Table 2, like in the case expressed in Table 1, in non-selection line, even though the signal electrode 4 is either of the H voltage and the L voltage, the polar liquid 16 also stops without moving, and thus the display color on the display surface side does not change.

On the one hand, in the selection line, as described above, in accordance with the voltage applied to the signal electrode 4, the polar liquid 16 can be moved, and the display color on the display surface side can be changed.

Furthermore, in the image display device 1 according to the present embodiment, in addition to the combinations of the application of voltages, expressed in Table 1 and Table 2, the voltage applied to the signal electrode 4, has not only two values, which are the H voltage and the L voltage, and the voltage between the H voltage and the L voltage can be changed according to the information to be displayed on the display surface. That is, in the image display device 1, a gradation display is made possible by controlling the signal voltage Vd. Thus, the display element 10 that is excellent in display performance can be configured.

In the display element 10, configured as described above, according to the present embodiment, the surface active agent 19 is added to the polar liquid 16 and the oil (the insulating fluid) 17. Thus, in the display element 10 according to the present embodiment, the interfacial tensions of the polar liquid 16 and the oil 17 can be weakened unlike in an example in the related art, and as illustrated in FIG. 11, the integration of the polar liquids 16 between the adjacent pixel regions P can be prevented from occurring. As a result, in the display element 10 according to the present embodiment, a display defect can be prevented from occurring, unlike in the example in the related art.

Furthermore, according to the present embodiment, since the integration of the polar liquids 16 between the adjacent pixel regions P is prevented from occurring, the width of the rib 14 can be narrowed, and the opening rate of the display element 10 can be easily increased. Furthermore, the interval between the ribs 14 between the adjacent pixel regions P can be increased, and thus the increase in the moving speed of the polar liquid 16 can be easily accomplished.

Furthermore, according to the present embodiment, the amount of the surface active agent 19 added in every pixel region P is determined using the molar quantity corresponding to the surface area of the polar liquid 16. Thus, according to the present embodiment, the amount of the added surface active agent 19 can be defined as an appropriate value, and the integration of the polar liquids 16 between the adjacent pixel regions P can be securely prevented from occurring.

Furthermore, in the image display device 1 (the electric device) according to the present embodiment, since the display element 10 that can prevent the integration of the polar liquids 16 between the adjacent pixel regions P from occurring and thus can prevent the display defect from occurring is used in the display unit, the high-performance image display device 1 (the electric device) can be easily configured which is equipped with the display unit, excellent in the display quality.

Furthermore, in the display element 10 according to the present embodiment, the signal driver (the signal voltage application unit) 7, the reference driver (the reference voltage application unit) 8 and the scanning driver (the scanning voltage application unit) 9 apply the signal voltage Vd, the reference voltage Vr and the scanning voltage Vs to the signal electrode 4, the reference electrode 5 and the scanning electrode 6, respectively. Thus, according to the present embodiment, the display element 10 that is a type of matrix drive that has excellent display quality can be easily configured and the display color of each pixel region can be appropriately changed.

### Second Embodiment

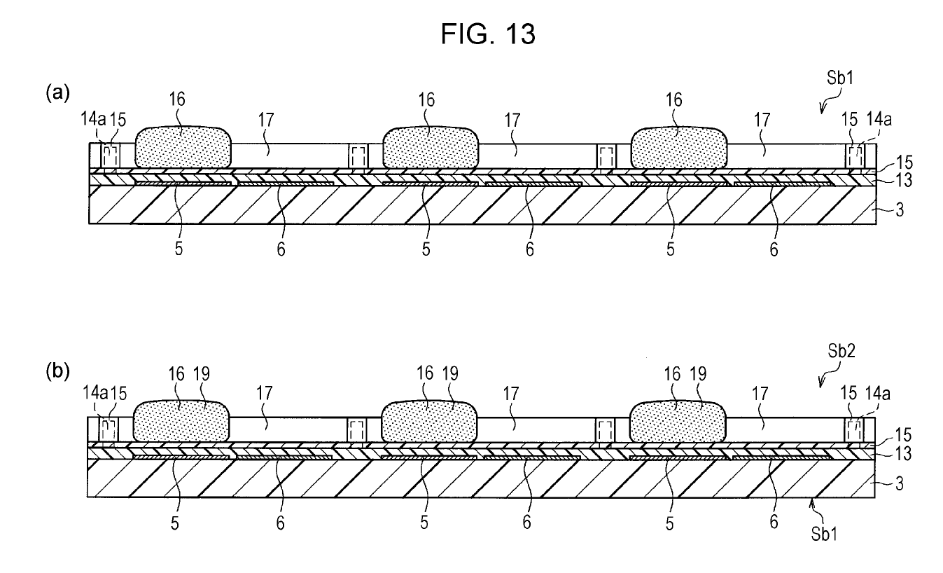

FIG. 13(a) is a view for describing a process of supplying a polar liquid and oil in a display element according to a second embodiment of the present invention, and FIG. 13(b) is a view for describing a process of adding a surface active agent in the display element according to a second embodiment of the present invention. In the drawings, a main difference between the present embodiment and the first embodiment described above is that the surface active agent is added to the polar liquid. Moreover, constituents common to the first embodiment described above are given like reference numerals, and repetitious description is omitted.

That is, as illustrated in FIG. 13(a), in the display element 10 according to the present embodiment, as in the first embodiment, the process of supplying the polar liquid 16 and the oil 17 is performed with respect to the intermediate substrate Sb1. Specifically, in the intermediate substrate Sb1, for example, the oil 17 is supplied into each of the pixel regions P that are defined by the partitioning by first and second rib members 14a and 14b, using a dispensing apparatus, or an ink jet apparatus for example. Subsequently, the polar liquid 16 is supplied to each pixel region P, using the dispensing apparatus or the ink jet apparatus for example.

Next, as illustrated in FIG. 13(b), the adding process of adding the surface active agent 19 is performed with respect to the intermediate substrate Sb1. Specifically, the surface active agent 19 is added to the polar liquid 16 within each pixel region P, for example, using the dispensing apparatus, or the ink jet apparatus. Thereafter, the surface active agent 19 moves to the oil 17, and as illustrated in FIG. 5, a polar group 19a is oriented toward the polar liquid 16, and a non-polar group 19b is oriented toward the oil 17 and toward the water repellent films 12 and 15. Thus, a finally-finished substrate Sb2 is obtained in terms of the lower substrate 3 in which the polar liquid 16 and the oil 17, to which the surface active agent 19 is added, are retained.

With the configuration described above, according to the present embodiment, the same operation and effect as according to the first embodiment can be accomplished. Furthermore, according to the present embodiment, since the surface active agent 19 is added to the polar liquid 16, the surface active agent 19 can be caused to function more securely than in the first embodiment. That is, according to the present embodiment, the surface active agent 19 can perform a function of reaching the interface between the polar liquid 16 and the oil 17 more securely than in the first embodiment.

### Third Embodiment

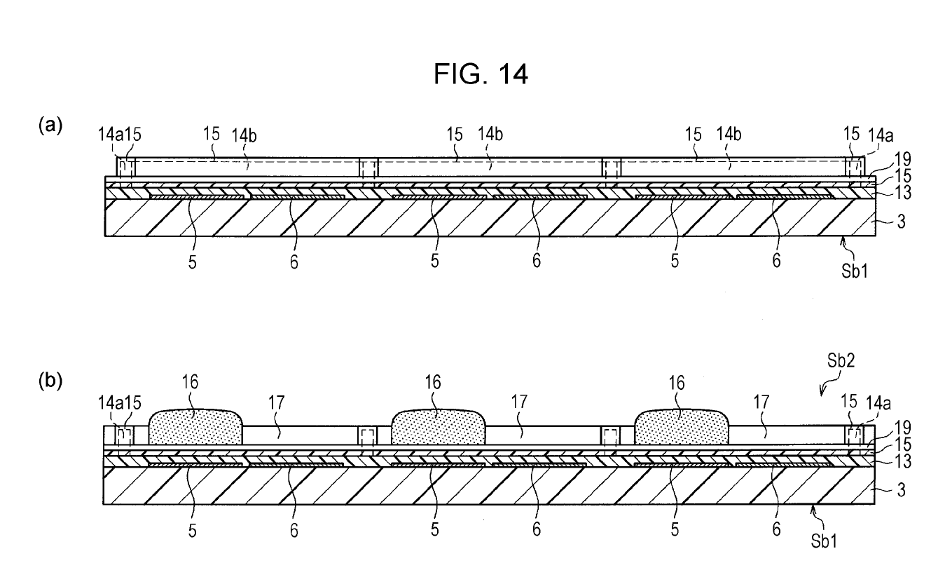

FIG. 14(a) is a view for describing a process of applying a surface active agent in a display element according to a third embodiment of the present invention, and FIG. 14(b) is a view for describing a process of supplying a polar liquid and oil in the display element according to the third embodiment of the present invention. In the drawings, a main difference between the present embodiment and the first embodiment described above is that the surface active agent is dispensed on the water repellent film on a lower substrate. Moreover, constituents common to the first embodiment described above are given like reference numerals, and repetitious description are omitted.

That is, as illustrated in FIG. 14(a), in the display element 10 according to the present embodiment, the process of applying the surface active agent 19 on the water repellent film 15 is performed after a process of film-forming the water repellent film 15. Specifically, the surface active agent 19 is applied to the intermediate substrate Sb1 so as to cover the water repellent film 15 in each pixel region P.

Subsequently, as illustrated in FIG. 14 (b), the process of supplying the polar liquid 16 and the oil 17 is performed with respect to the intermediate substrate Sb1. Specifically, with respect to the intermediate substrate Sb1, the oil 17 is supplied to each of the pixel regions P that are defined by the partitioning by first and second rib members 14a and 14b, using a dispensing apparatus, or an ink jet apparatus, for example. Subsequently, the polar liquid 16 is supplied to each pixel region P, using the dispensing apparatus or the ink jet apparatus, for example. Thereafter, the surface active agent 19 moves to an interface between the polar liquid 16 and the oil 17, and as illustrated in FIG. 5, a polar group 19a is oriented toward the polar liquid 16, and a non-polar group 19b is oriented toward the oil 17 and toward the water repellent films 12 and 15. Thus, the finally-finished substrate Sb2 is obtained in terms of the lower substrate 3 in which the polar liquid 16 and the oil 17, to which the surface active agent 19 is added, are retained.

With the configuration described above, according to the present embodiment, the same operation and effect as according to the first embodiment can be accomplished.

Moreover, in addition to what is described above, a configuration may also be provided in which the surface active agent 19 is dispensed on the water repellent film 12 on an upper substrate 2 and is dispensed on both of the water repellent films 12 and 15.

Moreover, all the embodiments described above are exemplary and are not limited. A technological scope according to the present invention is prescribed by scopes of claims, and modifications within a scope equivalent to the configurations described in the claims are also included in the technological scope according to the present invention.

For example, the case is described in which the present invention is applied to the image display device equipped with the display unit, but the present invention is not given any limitation as long as the image display device is an electric device equipped with the display unit that displays information including characters or images, and for example, the present invention can be used in the electric devices equipped with various display units, such as portable information terminals such as a PDA, an electronic organizer and the like, a display device that is attached to a personal computer, a television and the like, an electronic paper, and the like.

Furthermore, the case is described above, in which the electrowetting type display element that moves the polar liquid in response to the electric field applied to the polar liquid is configured, but the display element according to the present invention is not limited to this configuration, and can be applied to an electric field induction type display element that uses an electro-osmosis method, an electrophoresis method, a dielectrophoresis method, and the like, without being given any limitation, as long as the electric field induction type display element is one that can change the display color on the display surface side by moving the polar liquid within the display space using an external electric field.

However, as in each of the embodiments described above, rather, the case where the electrowetting type display element is configured makes it possible to move the polar liquid at a low drive voltage at a high speed. Furthermore, the electrowetting type display element is preferable in that the display color is changed in response to the movement of the polar liquid, and the high-brightness display element, excellent in the efficiency of the use of light from the backlight or external light, which is different than in a liquid crystal display device using a birefringence material such as a liquid crystal layer, and which is used in the information display, can be easily configured. What is more, because the switching element is not necessary to install in every pixel, the electrowetting type display element is preferable in that the high-performance matrix drive type display element can be configured at a low cost.

Furthermore, the configuration is described above, which uses the signal electrode, the scanning electrode, and the reference electrode, and the signal driver (the signal voltage application unit), the scanning driver (the scanning voltage application unit), and the reference driver (the reference voltage application unit). However, the present invention is not given any limitation, as long as the surface active agent is added to at least one of the polar liquid and the insulating fluid.

Specifically, the multiple signal electrodes and the multiple scanning electrodes are provided in the form of a matrix, so as to intersect each other, and the switching element, for example, a thin film transistor (TFT), is provided in each of the multiple pixel regions that are provided in the units of the intersection portions where the multiple signal electrodes and the multiple scanning electrodes intersect each other. Then, a configuration is provided in which the scanning electrode is connected to a gate of the thin film transistor and thus the application of the voltage from the scanning voltage application unit is performed. Furthermore, a configuration may be provided in which the signal electrode is connected to a base of the thin film transistor, and the application of the voltage from the signal voltage application unit is performed, and a configuration may be provided in which the moving operation of the polar liquid is performed by connecting a drain of the thin film transistor to the pixel electrode provided in every pixel region and thus supplying the voltage from the signal electrode.

However, as in each of the embodiments described above, rather, the case where the reference electrode and the reference driver (the reference voltage application unit) are provided is preferable in that the matrix drive type display element can be configured which can prevent the display defect from occurring, without providing the switching element in every pixel region.

Furthermore, the case where a transmission type display element equipped with the backlight is configured is described above, but the present invention is not limited to this configuration, and can be applied also to a reflection type display element that has a light reflection portion such as a diffusion reflection plate, and to a semi-transmission type display element that concurrently uses the light reflection portion and the backlight.

Furthermore, according to the first, second and third embodiments, the configuration in which the surface active agent is added to each oil (the insulating fluid), the configuration in which the surface active agent is added to the polar liquid, and the configuration in which the surface active agent is dispensed on the water repellent film are described above. However, the present invention is not limited to the configurations described above, and any configuration may be possible in which the surface active agent is added to at least one of the polar liquid and the insulating fluid.

Furthermore, the case is described above, in which the aqueous solution of potassium chloride is used for the polar liquid, but the polar liquid according to the present invention is not limited to this aqueous solution. Specifically, what includes electrolyte, such as zinc chloride, potassium hydroxide, sodium hydroxide, alkali metal hydroxide, zinc oxide, sodium chloride, lithium salt, phosphoric acid, alkali metal carbonate, and ceramics having oxygen ion conductivity, can be used for the polar liquid. Furthermore, in addition to water, organic solvent, such as alcohol, acetone, formamide, and ethylene glycol, can be used for the solvent. Furthermore, for the polar liquid according to the present invention, ionic liquid (ordinary temperature molten salt) can be used which includes a positive ion as pyridine basis, alicyclic group amine basis, or aliphatic amine basis, and a negative ion such as fluorine basis, for example, fluoride ion, or triflate.

Furthermore, the polar liquid according to the present invention includes a conductive liquid that has conductivity, and a liquid that has high dielectricity, and that has a relative dielectric constant of a predetermined level or above, preferably, a relative dielectric constant of 15 or more.

However, as in each of the embodiments described above, rather, the case where an aqueous solution in which a predetermined electrolyte is dissolved is used for the polar liquid is preferable in that ease of handling is excellent and a simply-manufactured display element can be easily configured.

Furthermore, the case where the non-polar oil is used is described above, but the present invention is not limited to the non-polar oil. An insulating fluid that does not mix with the polar liquid may be possible, and for example, instead of the oil, air, specifically, inert gas such as helium, neon, or argon, or nitrogen may be used. Furthermore, silicone oil, fat-based hydrocarbon or the like can be used as the oil. Furthermore, the insulating fluid according to the present invention includes a fluid that has the relative dielectric constant of the predetermined level or below, preferably, the relative dielectric constant of 5 or below.

However, as in each of the embodiments described above, rather, the case where the non-polar oil that has not compatibility with the polar liquid is used is preferable in that a droplet of the polar liquid is easier to move in the non-polar oil, compared to the case where the air or the polar liquid are used, and thus the polar liquid is possible to move at a high speed, thereby switching the display color at a high speed.

Furthermore, the case is described above, in which the signal electrode is provided on the upper substrate (the first substrate), and the reference electrode and the scanning electrode are provided on the lower substrate (the second substrate). However, according to the present invention, the reference electrode and the scanning electrode may be provided on one of the first and second substrates, in a state where the signal electrode is provided within the display space, so as to come into contact with the polar liquid, and is electrically mutually insulated from the polar liquid. Specifically, for example, the signal electrode may be provided midway between the first and second substrates, and the reference electrode and the scanning electrode may be provided on the first substrate.

Furthermore, the case is described above, in which the reference electrode and the scanning electrode are provided in the effective display region and the non-effective display region, respectively, but the present invention is not limited to this configuration, and the reference electrode and the scanning electrode may be provided in the non-effective display region and the effective display region, respectively.

Furthermore, the case is described above, in which the reference electrode and the scanning electrode are provided on the surface of the lower substrate (the second substrate), on the display surface side, but the present invention is not limited to this configuration, and the reference electrode and the scanning electrode may be used which is buried in the second substrate, described above, made from the insulating material. In a case of this configuration, the second substrate can be concurrently used as the dielectric layer, and the provision of the dielectric layer can be omitted. Furthermore, a configuration may be provided in which the signal electrode is provided directly on the first and second substrates that are concurrently used as the dielectric layer and in which the signal electrode is provided within the display space.

Furthermore, the case is described above, in which the transparent electrode material is used to configure the reference electrode and the scanning electrode, but according to the present invention, only one electrode of the reference electrode and the scanning electrode, which is provided so as to face the effective display region of the pixel, may be configured from the transparent electrode material, and an opaque electrode material, such as aluminum, silver, chromium, or the like, can be used for the other electrode, which does not face the effective display region.

Furthermore, the case is described above, in which the belt-shaped reference electrode and scanning electrode are used, but each shape of the reference electrode and the scanning electrode according to the present invention is not limited to this shape. For example, in the reflection type display element in which the efficiency of the use of light being used in displaying the information is decreased, compared to the transmission type display, a shape in which light loss is difficult to occur may be possible such as a line-shape or a net-shape.

Furthermore, the case is described above, in which the linear shaped wiring is used in the signal electrode, but the signal electrode according to the present invention is not limited to this shape, and the wiring can be used which takes on other shapes, such as the net-shape.

Furthermore, the case is described above, in which the pixel for each color of RGB is provided on the display surface side, using the polar liquid colored in black and the color filter layer, but the present invention is not limited to this configuration, and the multiple pixel regions may be provided corresponding to the multiple colors, the full color display of which is possible on the display surface, respectively. Specifically, the multiple color polar liquid can be used which are colored in RGB, CMY, which are cyan (C), magenta (M), yellow (Y), RGBYC, or the like.

Furthermore, the case is described above, in which the color filter layer is formed on the surface of the upper substrate (the first substrate), on the non-display surface side, but the present invention is not limited to this configuration, and the color filter layer can be provided on the surface of the first substrate, on the display surface side, or can be provided on the lower substrate (the second substrate). In this manner, rather, the case where the color filter layer is used is preferable in that the simply-manufactured display element can be easily configured, compared to the case where the multiple color polar liquids are prepared. Furthermore, the case where the color filter layer is used is preferable also in that the effective display region and the non-effective display region can be arranged in the display space, appropriately and securely, by the color filter portion (the opening portion) and the black matrix portion (the light blocking film) that are included in the color filter layer, respectively.

### INDUSTRIAL APPLICABILITY

The present invention is useful to a display element that can prevent integration of polar liquids between adjacent pixel regions from occurring and thus can prevent a display defect from occurring, and to an electric device that uses the display element.

### REFERENCE SIGNS LIST

1 IMAGE DISPLAY DEVICE (ELECTRIC DEVICE)
2 UPPER SUBSTRATE (FIRST SUBSTRATE)
3 LOWER SUBSTRATE (SECOND SUBSTRATE)
4 SIGNAL ELECTRODE
5 REFERENCE ELECTRODE
6 SCANNING ELECTRODE
7 SIGNAL DRIVER (SIGNAL VOLTAGE APPLICATION UNIT)
8 REFERENCE DRIVER (REFERENCE VOLTAGE APPLICATION UNIT)
9 SCANNING DRIVER (SCANNING VOLTAGE APPLICATION UNIT)
10 DISPLAY ELEMENT
11. COLOR FILTER LAYER
11r, 11g, 11b COLOR FILTER PORTION(OPENING PORTION)
11s BLACK MATRIX PORTION (LIGHT BLOCKING FILM)
13 DIELECTRIC LAYER
14 RIB
14a FIRST RIB MEMBER
14b SECOND RIB MEMBER
16 POLAR LIQUID
17 OIL (INSULATING FLUID)
19 SURFACE ACTIVE AGENT
S DISPLAY SPACE
P PIXEL REGION
P1 EFFECTIVE DISPLAY REGION
P2 NON-EFFECTIVE DISPLAY REGION

1. A display element which includes a first substrate that is provided on a display surface side, a second substrate that is provided on a non-display surface side of the first substrate so that a predetermined display space is formed between the first substrate and the second substrate, an effective display region and a non-effective display region that are defined with respect to the display space, and a polar liquid that is enclosed within the display space so as to be movable toward the effective display region, or toward the non-effective display region, and in which a display color on the display surface side is changeable, by moving the polar liquid, the display element comprising:
a plurality of signal electrodes which are provided within the display space so as to come into contact with the polar liquid and which are arranged along a predetermined arrangement direction;
a plurality of scanning electrodes which are provided on one of the first and second substrates, in a state of being electrically insulated from the polar liquid, so as to be arranged in one of the effective display region and the non-effective display region, and which are provided so as to intersect the plurality of signal electrodes;
a plurality of pixel regions, each of which is provided at an intersection portion where the signal electrode and the scanning electrode intersect each other;
a rib which is provided on at least one of the first and second substrates so as to internally partition the display space corresponding to each of the plurality of pixel regions; and
an insulating fluid which is enclosed within the display space so as to be movable in every pixel region and which does not mix with the polar liquid,
wherein a surface active agent is added to at least one of the polar liquid and the insulating fluid.

2. The display element according to claim 1,
wherein an amount of the surface active agent added in every pixel region is determined using a molar quantity corresponding to a surface area of the polar liquid in the pixel region.

3. The display element according to claim 1, further comprising:
a signal voltage application unit which is connected to the plurality of signal electrodes, and which applies a signal voltage within a predetermined voltage range to each of the plurality of the signal electrodes in accordance with information that is displayed on the display surface side; and
a scanning voltage application unit which is connected to the plurality of scanning electrodes, and which applies one of a selection voltage that allows the polar liquid to move within the display space and a non-selection voltage that disallows the polar liquid to move within the display space, to each of the plurality of the scanning electrodes in accordance with the signal voltage.

4. The display element according to claim 1,
wherein the plurality of pixel regions are provided corresponding to a plurality of colors with which a full color display is possible on the display surface side.

5. The display element according to claim 1, further comprising:
a plurality of reference electrodes which are provided on one of the first and second substrates, in a state of being electrically insulated from the polar liquid and the scanning electrodes, so as to be arranged in the other of the effective display region and the non-effective display region, and which are provided so as to intersect the plurality of signal electrodes; and
a reference voltage application unit which is connected to the plurality of reference electrodes, and which applies one of the selection voltage that allows the polar liquid to move within the display space and the non-selection voltage that disallows the polar liquid to move within the display space, to each of the plurality of the reference electrodes in accordance with the signal voltage.

6. The display element according to claim 5,
wherein a dielectric layer is stacked on surfaces of the reference electrodes and the scanning electrodes.

7. The display element according to claim 1,
wherein the non-effective display region is defined by a light blocking film that is provided on one of the first and second substrates, and
wherein the effective display region is defined by an opening portion that is formed in the light blocking film.

8. An electric device which is equipped with a display unit that displays information including characters and images,
wherein the display unit includes the display element according to claim 1.
